(19) United States
(12) Patent Application Publication
(10) Pub. No.: US 2008/0318834 A1
(43) Pub. Date: Dec. 25, 2008

(54) Antimicrobial Lactoferrin Compositions for Surfaces, Cavities, and Foodstuff

(75) Inventors: Jenneke Adriana Cadee, Odijk (NL); Peter Dirk Tips, Heeswijk (NL); Geertruida Dorothea Van Someren, Eindhoven (NL)

Correspondence Address: THE WEBB LAW FIRM, P.C., 700 KOPPERS BUILDING, 436 SEVENTH AVENUE, PITTSBURGH, PA, 15219, US

(73) Assignee: CAMPINA B.V., Zaltbommel (NL)

(21) Appl. No.: 10/590,591

(22) PCT Filed: Feb. 24, 2004
(86) PCT No.: PCT/NL2004/001849

§ 371 Date: Sep. 3, 2008

(51) Int. Cl. A01N 63/02; A23L 3/3526

(52) U.S. Cl. 514/2; 426/286

(57) ABSTRACT

The present invention relates to a method and composition for decontaminating surfaces, in particular surfaces in the oral cavity or wounded skin, inert surfaces such as from surgical instruments, or food stuffs, such as meat, wherein the method consists of treating the surface with a solution of lactoferrin of acid pH; a solution of lactoferrin and EDTA; a solution of lactoferrin and EDTA of acid pH, or combinations thereof. The solutions may optionally further comprise a polysaccharide, preferably a polysaccharide negatively charged at about neutral pH, such pectin.

The present invention relates to a method for reducing the microbial contamination of surfaces and cavities/surroundings, in particular surfaces in the oral cavity or wounded skin or inert surfaces that need decontamination, or of food stuffs, such as meat and surfaces thereof, and to compositions for use in such method.

All these surfaces are prone to microbial contamination by bacteria, fungi, protozoa and viruses.

Bacteria are normal inhabitants of the digestive tract, the oral cavity being the first part of it. From the normal flora known as the indigenous or endogenous flora, specific bacteria may develop due to a change in the micro-environmental conditions and set up an opportunistic infection. Oral health is an equilibrium between endogenous bacteria and the oral defence system.

Oral defence is mainly based on physical barriers (keratinised epithelium, mucous production, salivary flush), production of chemical compounds (salivary enzymes and antibacterials, gingival fluid secretions, etc.), and inflammatory reaction. It is estimated that 100 billion bacteria from all oral surfaces are shed daily in the saliva. The total plaque flora constitutes about five percent of the salivary flora. About 300 different species can be isolated from the dental plaque alone. One mg of dental plaque contains about 10 million bacteria. The flora of clinically healthy gingiva is mainly composed of aerobic and facultative anaerobic bacteria. Subgingival flora associated with periodontitis is predominantly anaerobic. Other oral infectious diseases include caries, periapical infection, odontogenic infections, osteomyelitis and stomatitis.

In order to avoid the risk of developing oral infectious diseases, contamination of the oral cavity with unwanted bacteria and other microorganisms is to be avoided. This can be achieved by normal oral hygiene, such a regular brushing and flossing of the teeth, but sometimes this is not sufficient. The need thus exists for supporting products that can further reduce microbial contamination of the oral cavity. This is the first object of the invention.

In the absence of the traumatic injury, healthy skin lives in relative harmony with bacteria—non-pathogens and pathogens alike. Quantitative assays of tissue biopsies show bacterial densities in the range of 10³ organisms per gram. Most cutaneous bacteria live in the interstices of epidermal recesses—sweat glands, hair follicles, and other skin appendages. Nevertheless, the skin serves as an important barrier to infection.

Many variables can influence bacterial growth within the skin, such as tissue pH, dryness of the outer skin layers, and local secretions. The fatty acids produced in sebaceous glands are particularly effective inhibitors of streptococcal growth. However, an injury changes the equilibrium dramatically. Even minimal trauma such as shaving will increase bacterial levels. A burn will destroy the keratin barrier against bacterial invasion. A laceration exposes deeper tissue layers.

In order to avoid infection of the wound, contamination thereof with surrounding bacteria should be avoided. It is a second object of the invention to provide a means for reducing microbial contamination of a wound and the surrounding tissues.

Food stuffs and in particular food surfaces are prone to microbial contamination by bacteria, fungi, protozoa and viruses.

The total viable count of bacteria on fresh meat or a meat product sets a limit to its shelf-life. Meat will “spoil” when the total viable counts become too high. Although the edible tissues of a healthy meat animal are essentially sterile prior to slaughter, because various innate host defence mechanisms at the external and internal organ surfaces create an effective barrier and prevent microorganisms from invading a live animal, the natural defences against invading microbes virtually disappear as soon as the animal is slaughtered, and the exposed tissues become highly susceptible to microbial colonization and proliferation. Contamination during slaughtering and processing, and further contamination during storage, temperature, pH and relative humidity can lead to spoilage of the meat and even worse, to food poisoning of the consumer.

It is therefore a further object of the invention to provide a means for reducing the microbial contamination of meat and other food products.

Lactoferrin is a versatile, bio-active milk protein that plays an important role in the immune system response and helps protect the body against infections. Besides the stimulation of the immune system, lactoferrin also prevents the growth of pathogens, exerts antibacterial and antiviral properties, controls cell and tissue damage caused by oxidation, and facilitates iron transport.

It is the object of the invention to improve the antimicrobial activity of lactoferrin for use in decontamination applications.

This object can be achieved by means of a method for reducing the microbial contamination on surfaces and surroundings, comprising treating the surface with one or more of the following:

a) a solution of lactoferrin of acid pH;

b) a solution of lactoferrin and a metal chelating agent, in particular EDTA;

c) a solution of lactoferrin and metal chelating agent, in particular EDTA, of acid pH.

The acid pH is a pH below 5, preferably below 4, more preferably below 3, even more preferably below 2.5, most preferably about 2. Lower pH's up to pH 1 are allowed according to the invention but usually not necessary.

It was furthermore found that the use of a polysaccharide, preferably a polysaccharide that is negatively charged at about neutral pH (e.g. pectin, carrageenan, heparin, agar-agar), further enhances the antimicrobial activity of the composition of the invention. The amount of the polysaccharide is 0.001-0.2% (w/v), preferably 0.01-0.1% (w/v), most preferably about 0.02% (w/v).

Suitable examples of metal chelating agents for use in the invention are EDTA and phosphonic acid. The latter is in particular suitable for use in oral care applications.

When EDTA is added to the lactoferrin solution, the pH can be closer to neutral to achieve a similar decontamination as found at a lower pH without EDTA. Furthermore, it was established that EDTA alone, i.e. without lowering the pH to values below 5, also enhances the antimicrobial activity of lactoferrin solutions.

A solution of 2% (w/v) lactoferrin and 1 mM EDTA has a pH of about 5. Such a solution is useful for the invention without further adjustment of the pH. When adjustments of the pH to a more acidic range are made this is called “a solution of lactoferrin and EDTA of acid pH”.

In either case, i.e. with or without further pH adjustment to a more acidic value, the concentration of EDTA in the solution is 0.1 to 10 mM, preferably 0.5 to 5 mM, most preferably about 1 mM.

The necessary amount of lactoferrin can be determined by the person skilled in the art but the concentration in the solution will suitably be 0.2 to 20% (w/v), preferably 0.5 to 12% (w/v), more preferably 1 to 8% (w/v), even more preferably 2 to 6% (w/v), most preferably about 2% (w/v).

One type of surfaces to be treated with the method of the invention is suitably the oral cavity or wounded skin. Other surfaces can also be envisaged, for example inert surfaces like in surgical instruments (surgical cutting blades, clamps, scissors, tubes etc.).

The lactoferrin solution of the invention is effective against a wide variety of microbes including bacteria, fungi, protozoa and viruses.

Microbes of the oral cavity that can be controlled with the method according to the invention are for example Streptococcus mutans, Streptococcus sanguis, Streptococcus sobrinus, Streptococcus gordonii, Streptococcus intermedius, Streptococcus anginosus, Actinomyces viscosus, Actinomyces israelii, Actinomyces gerencseriae, Porphyromonas gingivalis, Fusobacterium nucleatum, Veillonella parvula, Actinomyces naeslundii, Veillonella parvula, Fusobacterium nucleatum.

In wound care applications, for example the following micro-organisms can be controlled: Escherichia coli, Salmonella typhimurium, Enterobacter aerogenes, Enterobacter cloacae, Proteus vulgaris, Proteus mirabilis, Pseudomonas aeruginosa, Klebsiella spp, e.g. Klebsiella pneumoniae, Serratia marcessens, Staphylococcus aureus, Staphylococcus epidermis, Streptococcus pyogenes, Streptococcus faecalis, Providencia spp., Enterococcus faecium, Enterococcus faecalis, Peptostreptococcus spp., Bacteroides spp., Candida albicans and human fungal species like Trichophyton mentagrophytes, Trichophyton tonsurans, Trichophyton rubrum, Epidermophyton floccosum, Microsporum gypseum.

The lactoferrin solution of the invention is also effective against a wide variety of microbes that may constitute a threat to food stuffs, including bacteria, fungi, protozoa and viruses, in particular food-borne pathogens, food-borne radiation-resistant bacteria, and food spoilage microorganisms. Representative bacteria that can be controlled by the method as claimed include enterotoxigenic Escherichia coli, enteropathogenic Escherichia coli, Shigella dysenteriae, Shigella flexneri, Salmonella typhimurium, Salmonella abony, Salmonella dublin, Salmonella hartford, Salmonella kentucky, Salmonella panama, Salmonella pullorum, Salmonella rostock, Salmonella thompson, Salmonella virschow, Campylobacter jejuni, Aeromonas hydrophila, Staphylococcus aureus, Staphylococcus hyicus, Staphylococcus epidermidis, Staphylococcus hominis, Staphylococcus warineri, Staphylococcus xylosus, Staphylococcus chromogenes, Listeria, Campylobacter, Bacillus cereus, Bacillus subtilis, Candida albicans, and radiation-resistant bacteria, such as Brochothrix thermospacta, Bacillus pumilus, Enterococcus faecium, Deilnococcus radiopugnans, Deinococcus radiodurans, Deinobacter grandis, Acinetobacter radioresistens, Methylobacterium radiotolerans. Another surface to be treated with the method of the invention is suitably meat. The method of the invention was found to be very effective in reducing contamination of meat with verotoxic E. coli, including the serotype O157:H7.

The pH of the solution may increase after application to the surface, and on the meat surface it will increase, because of its buffering capacity but the antimicrobial capacity of the solution is nevertheless maintained.

It was found that the lactoferrin needs only be treated with acid for a short time to gain its better activity. A suitable duration of the acid treatment varies from 30 sec to 7 days, preferably 10 minutes to 3 days, more preferably 1 to 24 hours, even more preferably 2 to 12 hours, most preferably about 4 hours. Therefore, it is also possible to subject the lactoferrin to a pre-treatment with acid and adjust the pH afterwards to a more neutral value using NaOH, sodium bicarbonate, etc. For wound care and oral care applications, a more neutral pH is desirable.

The pH of the lactoferrin solution can be lowered with both organic and inorganic acids. For wound and oral care the following acids are particularly useful: phosphoric acid, sulphuric acid, hydrochloric acid, lactic acid, citric acid, sorbic acid, benzoic acid, acetic acid, peracetic acid, peracetic acid in combination with hydrogen peroxide, or one or more combinations of these acids. For application to meat acids, like phosphoric acid, sulphuric acid, hydrochloric acid, lactic acid, citric acid, ascorbic acid, succinic acid, fumaric acid, maleic acid, acetic acid, peracetic acid, peracetic acid in combination with hydrogen peroxide, or one or more combinations of these acids, can be used. Strong acids are preferred in order to achieve a pH value low enough to achieve the enhanced antimicrobial effect of lactoferrin.

The invention further relates to compositions for reducing the microbial contamination of surfaces, which composition comprises lactoferrin and optionally EDTA, and has an acid pH. In the case of meat applications, a polysaccharide, preferably a polysaccharide negatively charged at about neutral pH, may be used alone or together with EDTA.

When the composition does not comprise EDTA it will be necessary to adjust the pH to an acidic value at or below pH 5. In the presence of EDTA in (demi) water, the pH is already about 5. When EDTA is present the pH can optionally be lowered further.

The amounts of lactoferrin, polysaccharide and EDTA and the preferred pH are as defined above.

The composition of the invention can be a solution, but also a dry blend of the various components or a composition obtained by drying the solution as a whole. The dry blend can be reconstituted with water, preferably demineralised water. Such dry blend comprises lactoferrin, and optionally EDTA and/or a polysaccharide, preferably a polysaccharide negatively charged at about neutral pH, in solid form, optionally together with acidifying components in case these are available in solid form. The dry blend can also comprise lactoferrin and optionally EDTA and/or a polysaccharide, preferably a polysaccharide negatively charged at about neutral pH, the pH of which can be adjusted after dissolution of the blend. In a further embodiment EDTA can be added after dissolution of a dry blend that does not yet contain EDTA. For oral applications, instead of EDTA another metal chelating agent, such as phosphonic acid, can be used. When the already acidified solution is dried to obtain the dry blend, the pH of the solution can be adjusted to neutral or near neutral prior to drying, such as spray drying, freeze drying, tumble drying.

“Solution” is to be understood as meaning anything that contains the active components lactoferrin and optionally a metal chelating agent, in particular EDTA, and/or the polysaccharide, preferably a polysaccharide negatively charged at about neutral pH, such as pectin, in dissolved form, i.e. varying from a fluid to a gel. For wound and oral care optional other components are salts, buffer components, preservatives. In oral care applications also colourings, flavouring, sweeteners (non-cariogenic) can be added. For meat applications, optional other components comprise oxalic acid or salts thereof; citric acid or salts thereof; sodium bicarbonate; salts such as sodium chloride, calcium chloride, potassium chloride, lactic acid salts, sodium diacetate; nisin; flavouring agents; colouring agents; preservatives, etc.

Preferably the composition is neutralized to approximately neutral pH (6-7) when applied in oral care and wound care applications. It was found that the composition still showed high antimicrobial activity even after neutralisation.

For wound care applications, the composition of the invention can take the form of a solution, spray, gel, wound dressing, cream, ointment, sanitary wipe, bandage.

The composition of the invention can be used for treating wound on all parts of the human or animal body.

The composition of the invention, when used in oral care, can be applied in the form of a mouth wash, tooth paste, gel, gargle solution, denture cleanser, chewing gum, dentifrice, spray, capsule, tablet.

In food applications, in particular in the decontamination of meat, the composition of the invention can be applied by means of spraying, immersing, coating, etc.

The composition of the invention is useful for decontamination of any food product prone to microbial contamination or proliferation. Such products include processed and unprocessed foodstuffs, vacuum/micro-aerophilic packed or under inert gas packing or not vacuum packed, for human or animal consumption. The composition is especially useful in treating whole muscle and ground meat products, including beef products, pork products and poultry products, such as sausages, salamis, hotdogs, hamburgers, fillet and the like. In addition, the composition is useful in treating processed deli meats such as sliced chicken, ham, pork, turkey, Filet Americain and the like.

The composition of the invention can be applied at any time during the preparation of the food product to be treated. For example, when the product is a meat, the composition can be applied during slaughter or during the carcass wash or, if the meat product is a ground meat product, during meat grinding or the preparation of comminuted meat or during manufacture. After application, the concentration of LF on the food surface typically ranges from 1 ng to 50 mg lactoferrin per cm² of food surface, preferably from 10 ng to 5 mg, more preferably from 0.1 mg to 0.5 mg per cm².

In some embodiments, the composition is used to form a film on the interior surface of casings before the casings are stuffed with a batter for making sausages, salamis, hot dogs or the like, for example by applying it as a fine spray. A suitable coating formulation is made by combining the composition of the invention with a film-forming agent such as carrageenan, gelatin or collagen (type-I and type-II). The anti microbial activity is retained and works to prevent microbial contamination of the encased food product or prevent outgrowth or detach harmful microorganisms. The composition of the invention is also useful in coatings for meat packaging materials, such as wax-coated wrappings, cellulosic or polyethylene liners used as packing materials in meat industry. The coating is stable with full retention of its antimicrobial activity.

The lactoferrin useful in accordance with the present invention includes lactoferrin isolated from mammalian sources (humans, cows, sows, mares, transgenic animals and the like), biological secretions such as colostrum, transitional milk, matured milk, milk in later lactation, and the like, or processed products thereof such as skim milk and whey. Also useful is recombinant lactoferrin, including recombinant human lactoferrin, that is cloned and expressed in either prokaryotic and eukaryotic cells. This includes bovine and (recombinant) human lactoferrin that shows at least 95% amino acid homology with native bovine or human lactoferrin.

The lactoferrin can be isolated by any conventional method, such as by chromatography (ion-exchange, both cation and anion; molecular-sieve or affinity). Suitable lactoferrin is also commercially available from for example DMV International Nutritionals, the Netherlands.

The present invention will be further illustrated in the Examples that follow. In the examples, the improved antimicrobial activity of the composition of the invention as compared to lactoferrin alone is demonstrated in an in vitro system (growth inhibition of E. coli ATCC 43895 in steam sterilized tryptic soy broth (TSB) or Ps. aeruginosa (Pak strain) in filter sterilized Luria Broth Base (LB)) and in oral and wound care test models. In the Examples reference is made to the following figures:

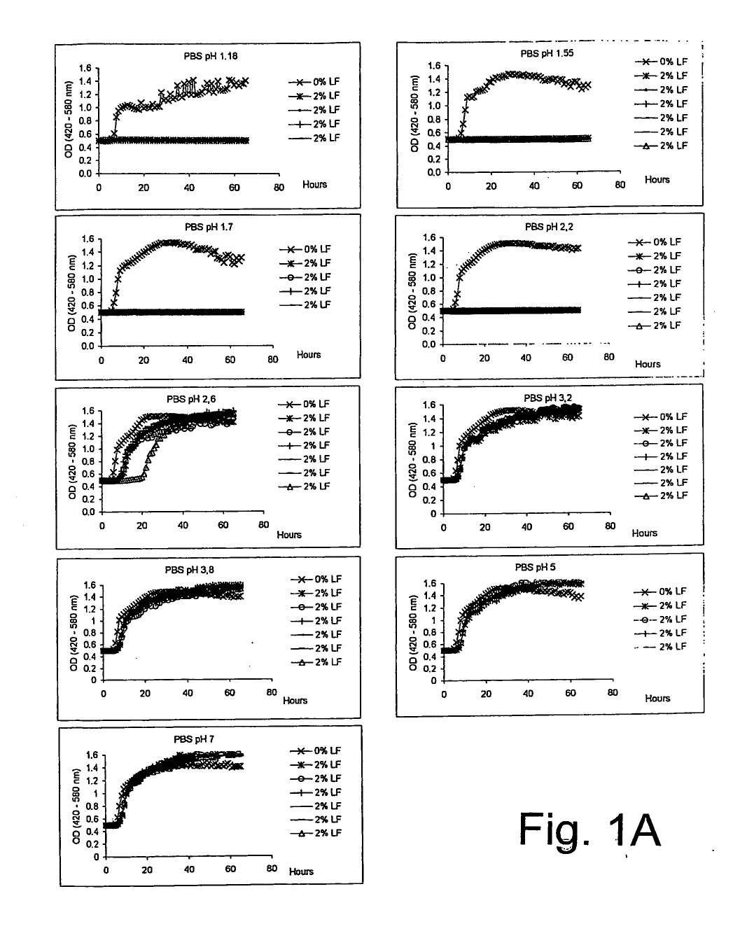

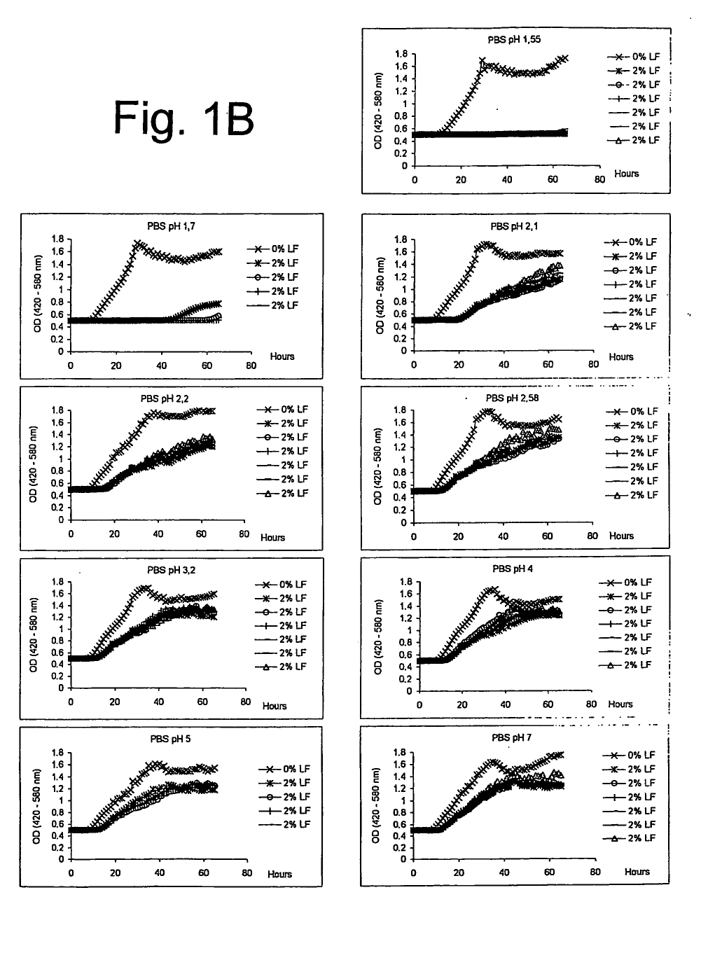

FIG. 1: The effect of pH on the antimicrobial activity of 2% (w/v) LF samples in PBS including growth control without LF.

FIG. 1A relates to E. coli O157:H7. The E. coli/lactoferrin ratio was 530 CFU's:1 mg lactoferrin.

FIG. 1B relates to Pseudomonas aeruginosa (Ps. aeruginosa/LF ratio was 200 CFU's:1 mg LF).

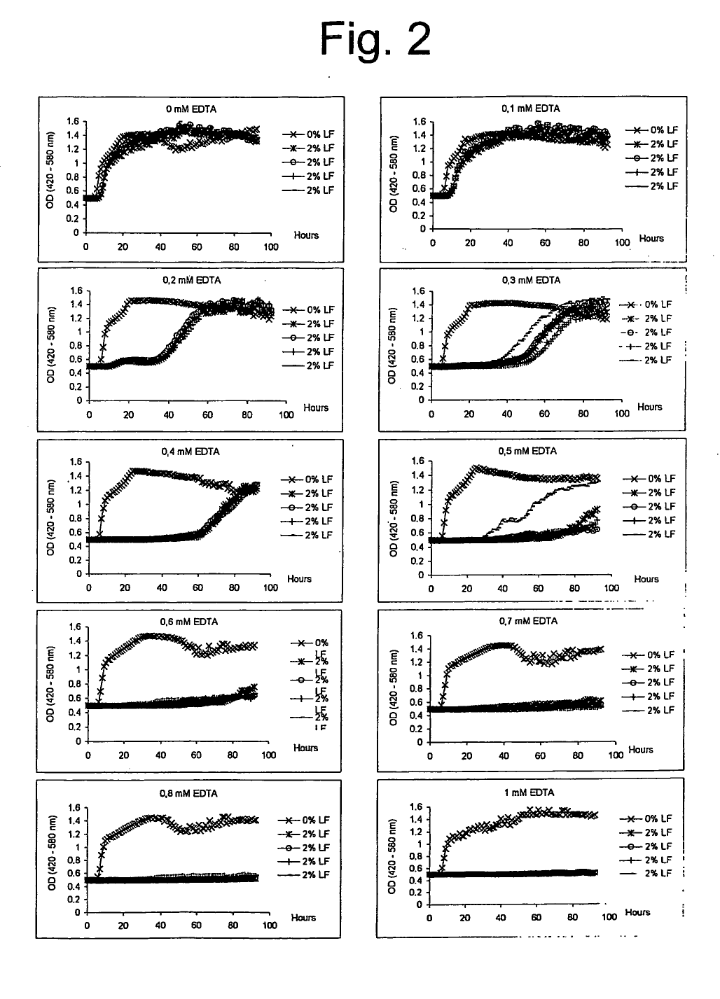

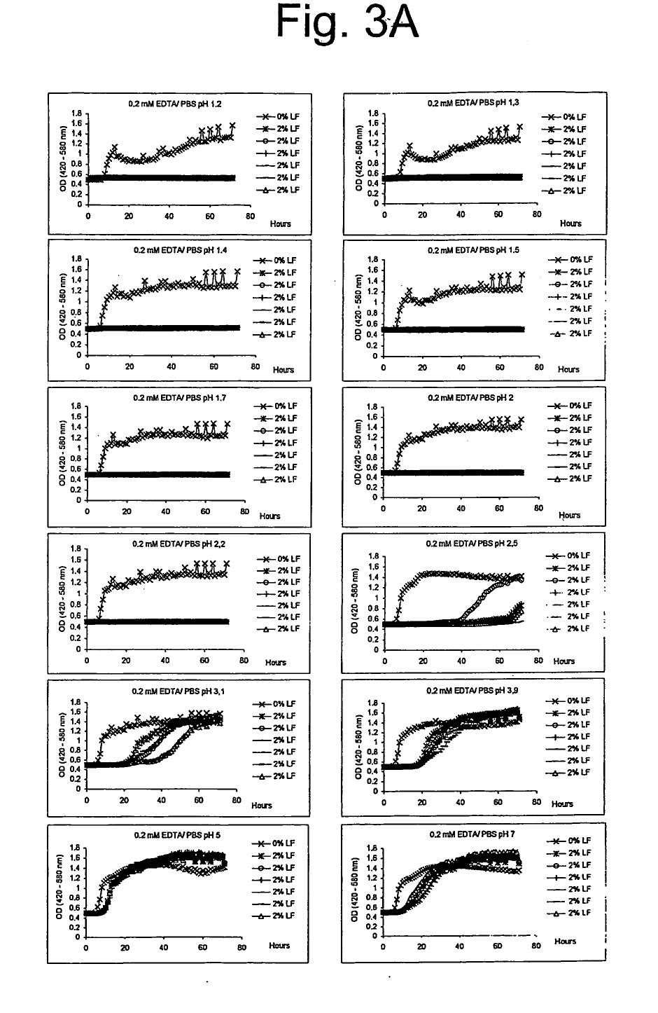

FIG. 2: The effect of different EDTA concentrations, 0 mM EDTA, 0.1 mM, 0.2 mM, 0.3 mM, 0.4 mM, 0.5 mM, 0.6 mM, 0.7 mM, 0.8 mM EDTA and 1 mM EDTA, on the growth of E. coli using demi water with and without 2% (w/v) LF. The E. coli/LF ratio was 270 CFU's:1 mg LF.

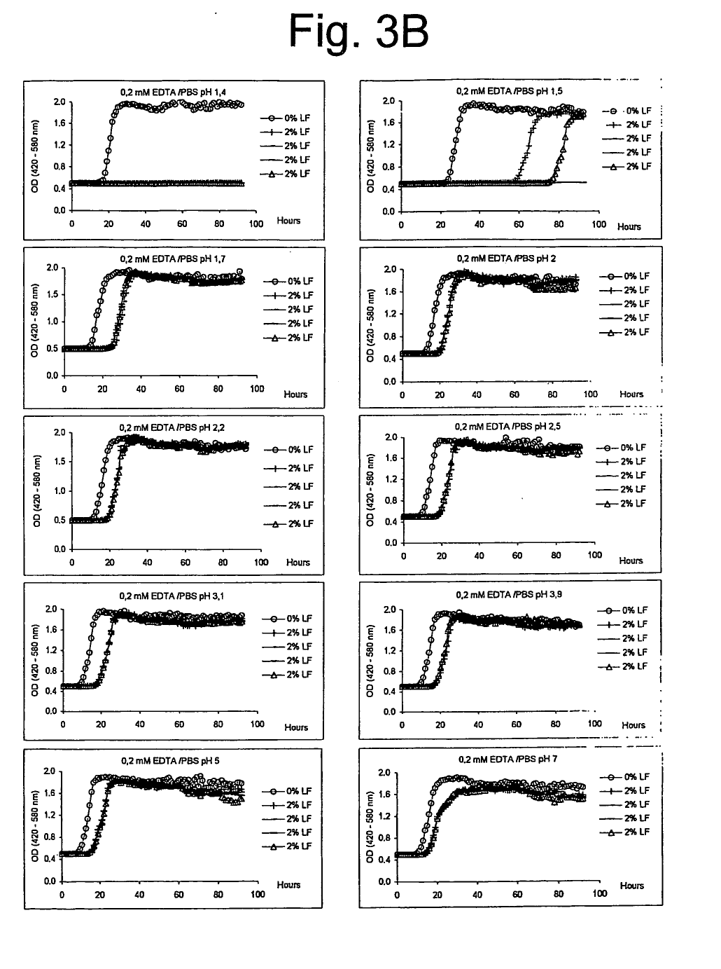

FIG. 3A: Effect of pH on the antimicrobial activity of 2% (w/v) LF/0.2 mM EDTA in PBS using and E. coli/LF ratio of 460 CFU's:1 mg LF.

FIG. 3B shows the effect of pH on the antimicrobial activity of 2% (w/v) LF/0.2 mM EDTA in PBS against Ps. aeruginosa (Ps. aeruginosa/LF ratio was 265 CFU's:1 mg LF).

### EXAMPLES

### Example 1

### Inhibition of Bacterial Growth in a Tryptic Soy Broth (TSB) Inhibition Assay

The compositions of the invention have been tested in an in vitro Tryptic Soy Broth (TSB) growth inhibition assay performed as follows.

A log-phase E. coli ATCC 43895 culture was prepared by culturing 2 ml of a stationary phase E. coli culture in 18 ml TSB for 2.5 hours at 37° C. Subsequently, 30 ml PBS were added and centrifuged at 3600 rpm for 10 minutes. The supernatant was discarded and the pellet was resuspended in 20 ml PBS. The E. coli concentration was diluted with PBS from about 2-5E8/ml to 1E4/ml.

To a stationary phase Ps. aeruginosa culture in 10 ml LB was added 40 ml PBS and was subsequently centrifuged at 3600 rpm for 10 minutes. The supernatant was discarded and the pellet was resuspended in 10 ml PBS. The Ps. aeruginosa concentration was diluted with PBS from about 1E9/ml to 2E3/ml.

Test solutions comprising 0 and 2% (w/v) lactoferrin (LF) were made in demi water or PBS, either with or without the suitable amount of EDTA. The pH was adjusted with hydrochloric acid.

The inhibition assay was performed by means of a Bioscreen C Analyzer System™ (Thermo Labsystems Oy, Finland) using specific flat-bottomed 100-wells plates. The wells were filled (n=4-8) according to table 1 below.

TABLE 1

| End | | | | Amount of | Amount |
|---|---|---|---|---|---|
| concentration | Absolute | | Amount of | E. coli or | of |
| of LF per | amount of | Test | 2xTSB or | Ps. | water/ |
| well | LF | sample | 2XLB | aeruginosa | buffer |
| 0.5% (w/v) | 1 mg | 50 ?1 | 100 ?1 | 50 ?1 | 0 ?1 |
| | | of 2% | | | |
| | | (w/v) | | | |
| growth | 0 mg | 50 ?1 | 100 ?1 | 50 ?1 | 0 ?1 |
| control (0% | | of 0% | | | |
| (w/v)) | | (w/v) | | | |
| sterility | 1 mg | 50 ?1 | 100 ?1 | 0 ?1 | 50 ?1 |
| control of | | of 2% | | | |
| 0.5% (w/v) LF | | (w/v) | | | |

The plates were then incubated at 37° C. The OD 420-580 nm was measured continuously by using the Bioscreen C Analyzer System™. The plates were shaken before every measurements (for 10 seconds).

### Example 2

### Effect of pH on the Antimicrobial Activity of Lactoferrin

A range of 2% (w/v) lactoferrin samples in PBS was made having pH's of 1.18, 1.55, 1.7, 2.2, 2.58, 3.2, 3.8, 5 and 7. These samples were added to the wells of a flat-bottomed 100-wells plate for the Bioscreen C Analyzer System™ according to the scheme in Table 1. Log-phase E. coli O157:H7 was used. As a growth control E. coli in TSB was used without LF. Experiments were performed in four- or six-fold.

FIG. 1A shows the results. It is clear that the E. coli growth was inhibited for at least 60 hours using a lactoferrin test sample with a pH below 2.5.

A similar experiment was performed with 200 CFU's/well Pseudomonas aeruginosa. The 2% (w/v) lactoferrin samples in PBS were made having pH's of 1.55, 1.7, 2.1, 2.2, 2.58, 3.2, 4, 5 and 7. FIG. 1B shows that at a pH of 1.7 or lower growth of Pseudomonas aeruginosa is inhibited for at least 45 hours.

### Example 3

### The Effect of EDTA on the Antimicrobial Activity of Lactoferrin

In this example the effect of different EDTA concentrations (0, 0.1, 0.2, 0.3, 0.4, 0.5, 0.6, 0.7, 0.8 and 1 mM for E. coli) on the antimicrobial activity of 2% (w/v) LF in demi water is demonstrated in the same manner as described in Example 2. The pH of the test solutions was not adjusted and was about 5 after dissolution of the EDTA.

FIG. 2 shows that the antimicrobial activity of LF on E. coli O157:H7 increases with increasing EDTA concentration (0-1 mM).

From these results it can be concluded that EDTA enhances the antimicrobial activity of lactoferrin.

### Example 4

### The Effect of EDTA and pH on the Antimicrobial Activity of Lactoferrin

The effect of pH on the antimicrobial activity of 2% (w/v) LF in PBS containing 0.2 mM EDTA was studied. Use was made of an in vitro growth inhibition assay as described in Example 1. The LF samples had a pH of 1.2, 1.3, 1.4, 1.5, 1.7, 2, 2.2, 2.5, 3.1, 3.9, 5 and 7.

FIG. 3A shows that the antimicrobial activity against E. coli O157:H7 of the samples having a pH below 2.5 was higher compared to the samples having a higher pH. From FIG. 3B it follows that at pH 1.4 the best growth inhibition is obtained.

### Example 5

### Use of the Composition of the Invention in Oral Care Applications

Testing in oral application was carried out as described in the in vitro model for the evaluation of antimicrobial/antiplaque agents using a constant depth film fermentor as described by M. Wilson, Methods in Enymology: Biofilms. San Diego, Academic Press, 1999; 310, 264-279. The total number of bacteria in a multi-species oral biofilm, consisting of S. mutans, Actinomyces naeslundii, Veillonella parvula and Fusobacterium nucleatum, on dentin plates was reduced after treatment with compositions of the invention as compared to the control (lactoferrin alone).

### Example 6

### Use of Compositions of the Invention in Wound Care Applications

A method for testing the invention is described by Hayward and Robson: “Animal Models of Wound Contraction”, in “Clinical and Experimental Approaches to Dermal and Epidermal Repair: Normal and Chronic Wounds”; A. Barbul, M. Caldwell and W. Eaglstein et al. (eds.), 1991, Wiley-Liss, New York; page 301-312. The “acute wound” model was used. It was found that compositions of the invention performed very well in the test.

### Example 7

The Effect of Lactoferrin Solutions of the Invention on E. coli Growth on Meat

This example shows the effect of different lactoferrin samples (with or without pH adjustment, with or without EDTA, with or without pectin) on the growth of a nalidixic acid resistant E. coli O157:H7 strain on a piece of meat. First the lactoferrin sample was applied onto the meat surface and subsequently the surface was inoculated with stationary fase E. coli.

The E. coli suspension was prepared starting from an overnight nalidixic acid resistant E. coli culture in 10 ml TSB (1×) containing 10 ?l of nalidixic acid stock at 37° C. without rotating. Subsequently, 40 ml PBS were added and the suspension centrifuged at 3600 rpm for 10 minutes. The supernatant was discarded and 10 ml PBS added. The E. coli concentration was approximately 10E9/ml. The E. coli suspension was further diluted with PBS to the concentration of interest.

The meat assay was performed as follows. Square pieces of meat (beef, 2-3 mm thick) were prepared using a cutting machine. The pieces of meat were placed on a plastic dish. The sterile bactainer (4 cm²) was pressed into the meat surface and 100 ?l or 300 ?l of an LF solution was added in drops on 4 cm², using a pipette. Subsequently, the meat squares were inoculated with 100 μl E. coli suspension in PBS. Incubation took place for 3 hours at room temperature (21-23° C.)

After incubation the inoculated meat area was cut out. The meat square was put into a stomacher bag with filter and 10 ml PBS was added. The bag was put in the stomacher for 2 minutes. The stomacher worked at high speed.

When the blender method was used, the meat square was put in a plastic tube containing 10 ml PBS and the piece of meat blended using an ultra turrax for 30 seconds at speed 6 (24000 rpm).

Serial 10-fold dilutions in PBS were made of the stomacher fluid or blender fluid (100 ?l fluid+900 ?l PBS). 50 ?l of 3 to 4 appropriate serial dilutions of the fluid were put on SMAC (Sorbitol MacConkey agar) plates with nalidixic acid (SMAC/NA). The plates were incubated overnight at 37° C. Counts were calculated as CFU's/4 cm².

Table 2 shows the results.

Table 2 relates to results of meat assays in which 100 ?l or 300 ?l of different LF samples were pipetted into the bactainer. Subsequently, 100 μl E. coli suspension in PBS was added. As control, meat inoculated with only E. coli was used (untreated meat).

TABLE 2

| | | E. coli/LF | | | Reduction |
|---|---|---|---|---|---|
| | | ratio | | | factor versus |
| | | (CFU's: mg | Amount of LF | Amount of EDTA | untreated |
| LF sample | pH of sample | LF) | (mg/bactainer) | (μmol/bactainer) | meat* |
| 2% LF in EB | 7 | 1833:1 | 6 | 0.3 | 1 |
| 2% LF/1 mM EDTA/0.02% | 2.5 | 1100:1 | 2 | 0.1 | 2-3 |
| pectin in PBS | | | | | |
| 2% LF/5 mM EDTA/0.02% | 2.5 | 1550:1 | 2 | 0.5 | 5 |
| pectin in PBS | | | | | |
| 2% LF/1 mM EDTA in demi | 5 | 2.2E+05:1 | 6 | 0.3 | 7 |
| water | | 2166:1 | 6 | 0.3 | 2 |
| | | 2500:1 | 6 | 0.3 | 5 |
| | | 1883:1 | 6 | 0.3 | 6 |
| 6% LF/1 mM EDTA in demi | 5 | 2500:1 | 6 | 0.1 | 3 |
| water | | 300:1 | | 0.1 | 2 |
| 4% LF/1 mM EDTA in demi | 5 | 1.1E+05:1 | 12 | 0.3 | 8 |
| water | | 1083:1 | 12 | 0.3 | 9 |
| | | 1250:1 | 12 | 0.3 | 10 |
| | | 258:1 | 12 | 0.3 | 9 |
| 4% LF/1 mM EDTA in demi | 2.5 | 258:1 | 12 | 0.3 | 5 |
| water | | | | | |
| 4% LF/1 mM EDTA/0.02% | 2.5 | 183:1 | 12 | 0.3 | 5 |
| pectin in PBS | | | | | 4 |
| 6% LF/1 mM EDTA in demi | 5 | 833:1 | 18 | 0.3 | 18 |
| water | | | | | |

${}^{*} Reduction factor versus untreated meat = \frac{average E . coli number of untreated meat}{average E . coli number of LF \text{-} treated meat}$
Reduction factor = 1 means that there is no reduction (no difference between untreated and treated meat).
Content of EB: 1 mM EDTA/100 mM NaCl/10 mM NaHCO₃.

From the above results it follows that the growth of E. coli O157:H7 on the meat surface can be reduced by lowering the pH of a lactoferrin sample containing EDTA with or without pectin. Compared to the reference lactoferrin sample with neutral pH (2% LF in EB), the E. coli growth can be reduced by decreasing the amount of LF, pH and use different amounts of EDTA. Furthermore, at lower pH increasing the amount of LF could further reduce the E. coli growth on the meat surface.

1-27. (canceled)

28. A method for reducing the microbial contamination of surfaces or foodstuffs, comprising treating the surface of the foodstuff with one or more of the following:
a) a solution of lactoferrin of acid pH;
b) a solution of lactoferrin and a metal chelating agent.

29. The method as claimed in claim 28, wherein the metal chelating agent is EDTA.

30. The method as claimed in claim 28, wherein the pH of the solution is increased to a value above the initial pH of the solution a) or b) before treatment of the surface, said increased pH value being between 2 and 8.5.

31. The method as claimed in claim 30, wherein the increased pH is between 5 and 8.

32. The method as claimed in claim 31, wherein the increased pH is between 6 and 7.

33. The method as claimed in claim 28, wherein the solution further comprises 0.001 to 0.2% (w/v) of one or more polysaccharides.

34. The method as claimed in claim 33, wherein the polysaccharide is selected from the group consisting of pectin, carrageenan, heparin and agar-agar.

35. The method as claimed in claim 28, wherein solution a) has a pH below 3 or b) has a pH below 5.

36. The method as claimed in claim 29, wherein the concentration of EDTA in the solution b) is more than 0.2 mM.

37. The method as claimed in claim 28, wherein the amount of lactoferrin in the solution is 0.2 to 20% (w/v).

38. The method as claimed in claim 28, wherein the surface to be treated is a surface in the oral cavity, wounded skin, or an inert surface, such as surgical instruments.

39. The method as claimed in claim 28, wherein the foodstuff to be treated is meat.

40. A solution for reducing the microbial contamination of surfaces or of foodstuffs, comprising lactoferrin, the solution:
a) having a pH below 3; or
b) containing a metal chelating agent and having a pH below 5.

41. A solution as claimed in claim 40, wherein the metal chelating agent is EDTA.

42. The solution as claimed in claim 40, wherein solution a) has a pH below 2.5.

43. The solution as claimed in claim 40, wherein solution a) has a pH below 2.1.

44. The solution as claimed in claim 40, wherein solution a) has a pH of about 2.

45. The solution as claimed in claim 40, further comprising 0.001 to 0.2% (w/v) of one or more polysaccharides.

46. The solution as claimed in claim 45, wherein the polysaccharide is selected from the group consisting of pectin, carrageenan, heparin and agar-agar.

47. The solution as claimed in claim 40, wherein 0.1 to 10 mM of EDTA is contained in the solution.

48. The solution as claimed in claim 40, wherein 0.2 to 10 mM of EDTA is contained in the solution.

49. The solution as claimed in claim 40, wherein 0.4 to 10 mM of EDTA is contained in the solution.

50. The solution as claimed in claim 40, wherein 0.6 to 10 mM of EDTA is contained in the solution.

51. The solution as claimed in claim 40, wherein 0.8 to 10 mM of EDTA is contained in the solution.

52. The solution as claimed in claim 40, wherein 1 to 10 mM of EDTA is contained in the solution.

53. A dry composition obtainable by drying a solution as claimed in claim 40.

54. A method for wound care, comprising administering the composition as claimed in claim 40.

55. A method for oral care, comprising administering the composition as claimed in claim 40.

56. A method for decontamination of inert surfaces, such as surgical instruments, comprising administering the composition as claimed in claim 40.

57. A method for decontamination of food products, comprising administering the composition as claimed in claim 40.
